(19) United States
(12) Patent Application Publication
(10) Pub. No.: US 2025/0074450 A1
(43) Pub. Date: Mar. 6, 2025

(54) VEHICULAR CABIN MONITORING SYSTEM

(71) Applicant: Magna Mirrors of America, Inc., Holland, MI (US)

(72) Inventors: Justin E. Sobecki, Rockford, MI (US); Austen C. Peterson, Hudsonville, MI (US)

(21) Appl. No.: 18/950,403

(22) Filed: Nov. 18, 2024

Related U.S. Application Data
(63) Continuation of application No. 18/390,052, filed on Dec. 20, 2023, now Pat. No. 12,145,616.
Application No. 18/390,052 is a continuation of application No. 17/649,723, filed on Feb. 2, 2022, now Pat. No. 11,851,080.
(60) Provisional application No. 63/199,918, filed on Feb. 3, 2021.

(51) Int. Cl. B60W 50/16; B60R 1/04; B60R 1/12; B60R 11/00; B60R 11/04; B60W 40/08; B60W 50/14; G06V 20/59

(52) U.S. Cl. CPC B60W 50/16; B60R 1/04; B60R 11/04; B60W 40/08; G06V 20/597; B60R 2001/1215; B60R 2011/0033; B60W 2050/143; B60W 2050/146; B60W 2420/403; B60W 2540/223

(57) ABSTRACT

A vehicular cabin monitoring system includes an interior-viewing camera disposed at an interior rearview mirror assembly within an interior cabin of a vehicle. A light emitter is disposed at the interior rearview mirror assembly and, when electrically operated, emits near infrared light to illuminate at least a portion of the interior cabin that is viewed by the interior-viewing camera. Image data captured by the camera is transferred to and is processed at an electronic control unit (ECU). The vehicular cabin monitoring system, via processing at the ECU of image data captured by the interior-viewing camera, (i) detects presence of an occupant occupying a seat within the vehicle and (ii) determines posture of the occupant relative to the occupied seat. Based at least in part on the determined posture of the occupant relative to the occupied seat, improper posture of the occupant relative to the occupied seat is determined.

### CROSS REFERENCE TO RELATED APPLICATIONS

The present application is a continuation of U.S. patent application Ser. No. 18/390,052, filed Dec. 20, 2023, now U.S. Pat. No. 12,145,616, which is a continuation of U.S. patent application Ser. No. 17/649,723, filed Feb. 2, 2022, now U.S. Pat. No. 11,851,080, which claims the filing benefits of U.S. provisional application Ser. No. 63/199,918, filed Feb. 3, 2021, which is hereby incorporated herein by reference in its entirety.

### FIELD OF THE INVENTION

The present invention relates to vehicular vision systems that use one or more cameras of a vehicle to monitor a driver of the vehicle and/or display video images derived from image data captured by the cameras of the vehicle.

### BACKGROUND OF THE INVENTION

It is known to provide a video display at the exterior rearview mirror assembly, such as described in U.S. Pat. No. 7,777,611, which is hereby incorporated herein by reference in its entirety, or to provide a video display at an interior rearview mirror assembly to display sideward and/or rearward images, such as described in U.S. Pat. No. 5,670,935, which is hereby incorporated herein by reference in its entirety. A variety of interior and exterior mirror assemblies with indicators are known in the art, such as U.S. Pat. Nos. 5,668,663; 5,355,284; 5,788,357; 6,257,746; 6,005,724; 5,481,409; 6,111,683; 6,045,243; 6,264,353; 6,512,624; 6,356,376; 2,263,382; 2,580,014; 3,266,016; 4,499,451; 4,588,267; 4,630,904; 4,623,222; 4,721,364; 4,906,085; 5,313,335; 5,587,699; 5,575,552; 5,436,741; 5,587,699; 5,938,320; 6,700,692 and 5,786,772, which are all hereby incorporated herein by reference in their entireties.

### SUMMARY OF THE INVENTION

A driver monitoring system (DMS) includes a camera that views a driver's head and body region in the vehicle cabin and an image processor that processes image data captured by the camera to determine posture of the driver sitting in the driver seat of the vehicle. The system may also or otherwise include a camera that views a passenger's head and body region at a passenger seat in the vehicle cabin, whereby the image processor processes image data captured by the passenger-viewing camera to determine posture of the passenger sitting in the passenger seat of the vehicle. The system, responsive to determination (via processing by the image processor of image data captured by the camera) that the driver's posture is poor (outside of a threshold range of acceptable postures or positions), generates an alert to the driver (or passenger) so the driver (or passenger) can improve his or her posture.

The system includes an electronic control unit (ECU) of the vehicle that receives image data captured by the camera and that may include the image processor for processing the captured image data. The ECU may output (such as via a coaxial cable) a signal to a video display of the interior rearview mirror assembly for displaying video images at the display screen based on the captured image data or for displaying a visible alert at the mirror reflective element of the interior rearview mirror assembly.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly having a driver monitoring and posture alert system;

FIG. 2 is a schematic block diagram of a vehicle posture detecting and alert system; and

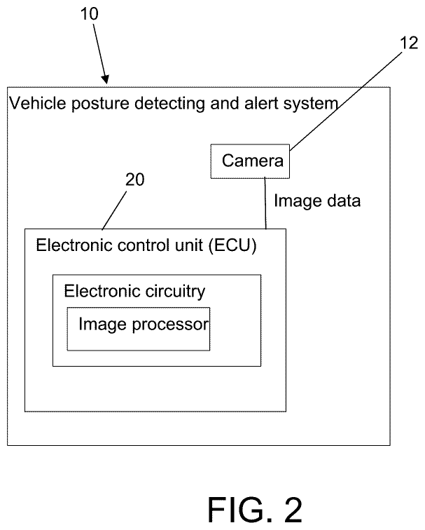

FIG. 3 is a perspective view of another interior rearview mirror assembly having another driver monitoring and posture alert system.

### DESCRIPTION OF THE PREFERRED EMBODIMENTS

A vehicle vision system and/or driver or driving assist system and/or driver monitoring system and/or alert system operates to capture images interior of the vehicle and may process the captured image data to monitor the driver of the vehicle (and/or one or more passengers of the vehicle). The system includes an image processor or image processing system that is operable to receive image data from one or more cameras and to provide an output to one or more alert devices or display devices for alerting the driver and/or passenger.

Referring now to the drawings and the illustrative embodiments depicted therein, a driver monitoring and posture alert system 10 includes a driver monitoring camera 12 that is disposed at an interior rearview mirror assembly 14 of the vehicle. The system 10 also includes a posture indicator 16 (such as one or more visible light-emitting light emitting diodes (LEDs)) and may also include one or more illumination devices 18 (such as one or more infrared LEDs) for illuminating the driver region to enhance image capture of the driver during low ambient lighting conditions.

The system 10 uses one or more driver monitoring system (DMS) cameras 12 (such as one that views the driver seat region of the vehicle and one that views the passenger seat region of the vehicle or a single camera that views both seat regions) to analyze and monitor the driver's and/or passenger's posture. The system 10 may allow for users to set their ideal posture position (such as via pressing a button or otherwise actuating a user input or human machine interface (HMI) to save the user's current posture as a baseline or target posture) or the system 10 may automatically define the ideal posture by analyzing the person's head and spine positions relative to the key features of the vehicle (e.g., relative to the vehicle seat, steering wheel, mirror, etc.).

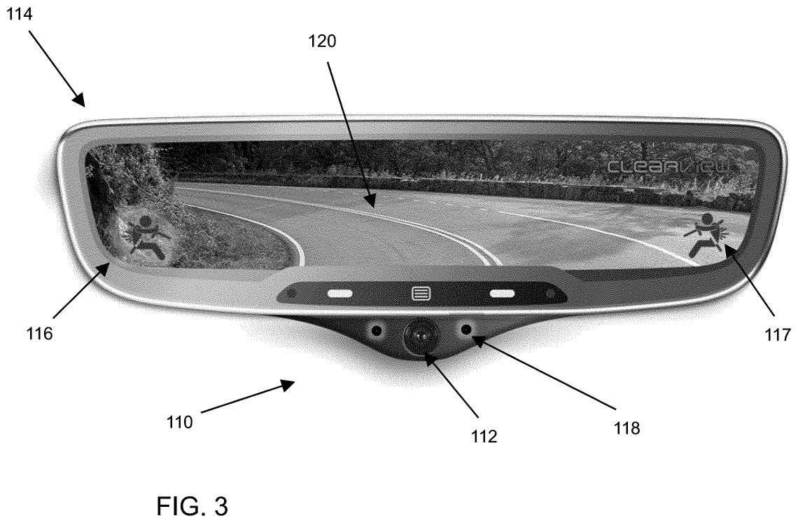

Referring to FIG. 3, the system 10 includes a control or electronic control unit (ECU) 20 having electronic circuitry and associated software, with the electronic circuitry including a data processor or image processor that is operable to process image data captured by the camera or cameras 12, whereby the ECU may monitor the driver and/or passenger. The controller or ECU (having electronic circuitry including an image processor) processes image data captured by the DMS camera 12 (and optionally or otherwise one or more other posture detecting cameras disposed within the cabin of the vehicle and viewing one or more seating areas in the vehicle) to determine the current posture of the driver or passenger. Responsive to determining that the driver's posture is more than a threshold amount outside of or different than the determined or selected proper posture, the system generates an alert to warn the driver when the driver's posture becomes poor.

Thus, the driver, when initially operating the vehicle, may actuate a “proper posture” input and the system may capture image data representative of the driver in the proper posture. The proper posture image data is stored in memory for use during that driving maneuver or trip by that driver and optionally for future driving maneuvers or trips by that driver. The system may also include a driver identification feature to determine if the driver in the vehicle is a driver that has previously stored proper posture data. While the driver operates the vehicle, the system may continuously or episodically monitor the driver and compare the determined current driver posture to the stored proper posture data. If the system determines that the driver's determined current posture differs from the stored proper posture by a threshold amount (e.g., the driver's head tilts or the driver slouches by more than a threshold amount compared to the stored posture data), the system generates an alert to the driver so the driver can adjust his or her posture back towards the proper posture/position.

The alert may comprise an audible sound (via one or more speakers in the vehicle), a verbal warning (via one or more speakers in the vehicle), a seat vibration (or steering wheel vibration or other suitable haptic alert), a light indicator 16, a light indicator 16 that changes color/brightness depending on how bad/good the posture is (e.g., a light that is green when the posture is good, and red when the posture is bad). Optionally, the light indicator 16 may comprise a single LED that simply lights up when the system 10 determines bad posture, or the light indicator 16 may comprise two LEDs (or a single LED that can emit different colors of light) such that red light is emitted when posture is determined to be poor and green light is emitted when posture is determined to be good. Optionally, the light indicator 16 may comprise a plurality of LEDs arranged in a row or column, where the number of LEDs (and optionally color too) energized changes with the determined degree of bad posture.

Although shown and described as having the camera 12 and alert device at the interior rearview mirror assembly 14, the monitoring and posture alert system 10 may be located at the instrument panel or at a center console or overhead console of the interior cabin of the vehicle.

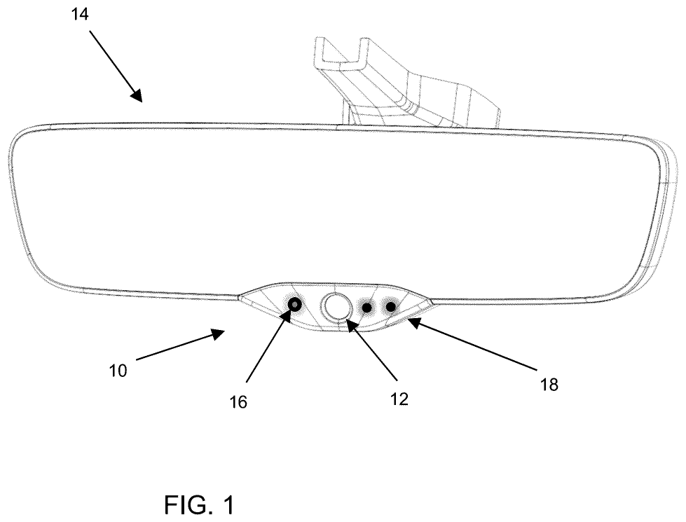

As shown in FIG. 1, the visible posture indicator or alert may comprise a light indicator 16 at the mirror head that illuminates to provide indication to the driver that is representative of the driver's posture. For example, the indicator 16 may be off and only activated when the posture is determined to be poor. In such an application, the indicator 16 may comprise a red indicator to indicate the poor posture when the indicator 16 is energized. Optionally, the indicator 16 may provide green light when the posture is determined to be good (within a threshold range of the targeted posture) and may provide red light when the posture is determined to be bad (outside of the threshold range of the targeted posture). The indicator 16 may flash red if the posture is outside of a further threshold range (very bad posture) or if the posture is determined to be bad for longer than a threshold period of time, in order to increase the likelihood that the driver sees the alert.

Optionally, and such as shown in FIG. 3, the driver monitoring and posture alert system 110 includes a driver monitoring system camera 112 and DMS illumination device 118 disposed at an interior rearview mirror assembly 114. The interior rearview mirror assembly may comprise a full mirror video display screen 120 disposed behind the mirror reflective element that is operable to display video images derived from image data captured by one or more exterior viewing cameras of the vehicle. The cameras may provide rearward video images for such a dual-mode interior rearview video mirror, which can switch from a traditional reflection mode to a live-video display mode, such as by utilizing aspects of the mirror assemblies and systems described in U.S. Pat. Nos. 10,442,360; 10,421,404; 10,166,924; 10,046,706; 10,029,614 and/or U.S. Publication Nos. US-2021-0245662; US-2021-0162926; US-2021-0155167; US-2019-0258131; US-2019-0146297; US-2019-0118717; US-2019-0047475 and/or US-2017-0355312, and/or International PCT Application No. PCT/US22/70062, filed Jan. 6, 2022 and published Jul. 14, 2022 as International Publication No. WO 2022/150826, which are all hereby incorporated herein by reference in their entireties.

The system 110 provides a posture indicator 116 at the video display screen, such as via a graphic overlay or iconistic display at the display screen. In the illustrated embodiment, the indicator 116 provides an iconistic representation of a driver with bad posture (and may be displayed as a red color) to alert the driver of his or her bad posture. The color and/or intensity of the iconistic indicator 116 may be adjusted responsive to the degree of bad posture and/or time that the driver (or passenger) maintains the bad posture. Optionally, the iconistic indicator 116 may flash and/or be accompanied by an audible alert based at least in part on the degree of bad posture and/or time that the driver (or passenger) maintains the bad posture. Similarly, the system 110 may provide a passenger side posture indicator 117 (which may be at the passenger side of the mirror) to alert a passenger of his or her bad posture. The icon and/or warning message may be displayed at or on the video mirror display screen or at or on any other of the vehicle's display screens (such as a center console display screen or the like).

Optionally, the system 110 may record the amount of time the driver has good posture versus bad posture and report the information to the vehicle as a matrix that the driver/passage can improve on over time. Thus, as the driver/passenger uses the system 110 over time, he or she can monitor progress and set goals for themselves.

Optionally, the system 110 may process captured image data to determine the driver's skeletal structure mapped from the driver's perceived body position. The system 110 may continually monitor the determined skeletal structure and compare it to a known best posture or a pre-set posture setting. Optionally, the system 110 may monitor the determined skeletal structure to determine a threshold change in posture over time (to determine a time-based posture change), and may alert the driver or passenger when the change exceeds a threshold amount over a given time period.

The interior rearview mirror assembly may comprise any suitable mirror assembly having a video display device disposed behind the mirror reflective element so as to be viewable through a partially reflective and partially visible light transmitting or transflective mirror reflector of the mirror reflective element when the display screen is powered. For example, and such as shown in FIG. 3, the interior rearview mirror assembly may comprise an auto-dimming electro-optic (such as electrochromic) mirror assembly that operates as a reflecting mirror when the display screen is off, and functions as a video mirror when the display screen is activated. Optionally, the mirror assembly may comprise a prismatic mirror reflective element (that is toggled between a daytime viewing position and a nighttime or anti-glare viewing position) having a video display screen disposed behind the transflective mirror reflector of the prismatic mirror reflective element.

The mirror head (including the mirror housing and reflective element and display) is mounted at a stay assembly or mounting structure, which is configured to attach at an interior portion of the vehicle (such as at an overhead console or headliner or at an in-cabin side of the vehicle windshield). The mirror head may be toggled between the mirror mode and the display mode by flipping a toggle tab at the bottom of the mirror head, which causes the mirror head to pivot about a generally horizontal pivot axis relative to the mirror stay.

The system may utilize aspects of the driver monitoring systems described in U.S. Pat. Nos. 10,065,574; 10,017,114; 9,405,120 and/or 7,914,187, and/or U.S. Publication Nos. US-2021-0323473; US-2021-0291739; US-2020-0202151; US-2020-0143560;US-2020-0320320; US-2018-0231976; US-2018-0222414; US-2017-0274906;US-2017-0217367; US-2016-0209647; US-2016-0137126; US-2015-0352953; US-2015-0296135; US-2015-0294169; US-2015-0232030; US-2015-0092042; US-2015-0022664;US-2015-0015710; US-2015-0009010 and/or US-2014-0336876, and/or U.S. patent application Ser. No. 17/450,721, filed Oct. 13, 2021, now U.S. Pat. No. 11,518,401, and/or U.S. provisional applications, Ser. No. 63/260,359, filed Aug. 18, 2021, Ser. No. 63/201,894, filed May 18, 2021, Ser. No. 63/201,757, filed May 12, 2021, Ser. No. 63/201,371, filed Apr. 27, 2021, Ser. No. 63/200,451, filed Mar. 8, 2021, Ser. No. 63/200,315, filed Mar. 1, 2021, Ser. No. 63/200,003, filed Feb. 9, 2021, which are hereby incorporated herein by reference in their entireties.

The cameras may comprise any suitable imaging sensor or camera, such as a pixelated imaging array or the like, such as a CMOS imaging array sensor, a CCD sensor or other sensors or the like, such as a camera or sensor of the types disclosed in commonly assigned, U.S. Pat. Nos. 7,965,336; 5,550,677; 5,760,962; 6,097,023 and 5,796,094, which are hereby incorporated herein by reference in their entireties. Optionally, the cameras may comprise a stereo imaging camera or the like, such as by utilizing aspects of the imaging systems described in U.S. Pat. Nos. 6,396,397 and/or 5,796,094, which are hereby incorporated herein by reference in their entireties. Optionally, the cameras may comprise an infrared or near infrared light sensitive camera and may be suitable for capturing images in low lighting conditions, and/or the camera may include or be associated with an illumination source (such as an infrared or near-infrared light emitting illumination source that, when actuated to emit infrared or near-infrared light at the side of the vehicle, enhances the camera's performance but is not visible or discernible to the driver of the vehicle), such as by utilizing aspects of the cameras described in U.S. Pat. Nos. 7,965,336; 5,550,677; 5,760,962; 6,097,023 and 5,796,094, which are hereby incorporated herein by reference in their entireties.

The mirror assembly may comprise any suitable construction, such as, for example, a mirror assembly with the reflective element being nested in the mirror casing and with a bezel portion that circumscribes a perimeter region of the front surface of the reflective element or with the mirror casing having a curved or beveled perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059and/or 8,529,108, which are hereby incorporated herein by reference in their entireties), or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 8,508,831; 8,730,553; 9,598,016 and/or 9,346,403, and/or U.S. Publication Nos. US-2014-0313563 and/or US-2015-0097955, which are hereby incorporated herein by reference in their entireties (and with electrochromic and prismatic mirrors of such construction are commercially available from the assignee of this application under the trade name INFINITY™ mirror).

The mirror assembly may include user inputs or actuatable switches or touch sensors or the like for user/driver control of one or more features of the mirror assembly and/or display system. The user inputs or touch sensors may comprise any suitable sensors or inputs, and may utilize aspects of the inputs and sensors described in U.S. Pat. Nos. 9,827,913; 9,598,016; 9,346,403; 8,508,831; 8,730,553; 7,224,324; 7,253,723; 7,255,451 and/or 8,154,418, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
an interior-viewing camera disposed at an interior rearview mirror assembly within an interior cabin of a vehicle equipped with the vehicular cabin monitoring system, wherein the interior-viewing camera views within the interior cabin of the vehicle;
wherein the interior-viewing camera is operable to capture image data;
a light emitter disposed at the interior rearview mirror assembly, wherein the light emitter, when electrically operated, emits near infrared light to illuminate at least a portion of the interior cabin that is viewed by the interior-viewing camera;
an electronic control unit (ECU) disposed at the vehicle, wherein the ECU comprises electronic circuitry and associated software, and wherein the electronic circuitry of the ECU comprises an image processor operable to process image data captured by the interior-viewing camera;
wherein image data captured by the interior-viewing camera is transferred to and is processed at the ECU;
wherein the vehicular cabin monitoring system, via processing at the ECU of image data captured by the interior-viewing camera, (i) detects presence of an occupant occupying a seat within the interior cabin of the vehicle and (ii) determines posture of the occupant relative to the seat that is occupied by the occupant; and
wherein, based at least in part on the determined posture of the occupant relative to the seat that is occupied by the occupant, improper posture of the occupant relative to the seat that is occupied by the occupant is determined.

2. The vehicular cabin monitoring system of claim 1, wherein image data captured by the interior-viewing camera is processed at the ECU to determine skeletal structure of the occupant mapped from a perceived body position of the occupant.

3. The vehicular cabin monitoring system of claim 1, wherein proper posture of a properly-postured occupant relative to the seat that is occupied by the occupant is stored in memory, and wherein a threshold degree of improper posture of the occupant is determined by the vehicular cabin monitoring system by comparing the determined posture of the occupant relative to the seat that is occupied by the occupant to the proper posture stored in memory.

4. The vehicular cabin monitoring system of claim 3, wherein an alert is generated responsive to the determined posture of the occupant relative to the seat that is occupied by the occupant being different than the proper posture stored in memory by at least a threshold amount.

5. The vehicular cabin monitoring system of claim 1, wherein the occupant is a passenger of the vehicle occupying a passenger seat within the interior cabin of the vehicle.

6. The vehicular cabin monitoring system of claim 1, wherein the occupant is a driver of the vehicle occupying a driver seat within the interior cabin of the vehicle.

7. The vehicular cabin monitoring system of claim 6, wherein posture of the driver is determined based at least in part on a determined head position of the driver relative to a steering wheel of the vehicle.

8. The vehicular cabin monitoring system of claim 6, wherein image data captured by the interior-viewing camera is processed to determine attentiveness of the driver of the vehicle.

9. The vehicular cabin monitoring system of claim 1, wherein posture of the occupant is determined based at least in part on a determined spinal position of the occupant relative to the seat that is occupied by the occupant.

10. The vehicular cabin monitoring system of claim 1, wherein an alert is generated responsive to determination of a threshold degree of improper posture.

11. The vehicular cabin monitoring system of claim 10, wherein the alert comprises actuation of a visible indicator that is viewable by the occupant of the vehicle.

12. The vehicular cabin monitoring system of claim 11, wherein the visible indicator is disposed at the interior rearview mirror assembly of the vehicle.

13. The vehicular cabin monitoring system of claim 11, wherein the visible indicator comprises a light emitting diode.

14. The vehicular cabin monitoring system of claim 11, wherein the alert comprises actuation of the visible indicator to emit red light.

15. The vehicular cabin monitoring system of claim 11, wherein the visible indicator emits green light when the vehicular cabin monitoring system is operating and the vehicular cabin monitoring system does not determine improper posture.

16. The vehicular cabin monitoring system of claim 11, wherein the visible indicator comprises an iconistic graphic overlay that is overlaid at video images displayed at a video display screen of the vehicle that is viewable by the occupant of the vehicle.

17. The vehicular cabin monitoring system of claim 16, wherein the video display screen is disposed at the interior rearview mirror assembly of the vehicle.

18. The vehicular cabin monitoring system of claim 10, wherein the alert comprises an audible alert.

19. The vehicular cabin monitoring system of claim 10, wherein the alert comprises a haptic alert.

20. A vehicular cabin monitoring system, the vehicular cabin monitoring system comprising:
an interior-viewing camera disposed at an interior rearview mirror assembly within an interior cabin of a vehicle equipped with the vehicular cabin monitoring system, wherein the interior-viewing camera views within the interior cabin of the vehicle;
wherein the interior-viewing camera is operable to capture image data;
a light emitter disposed at the interior rearview mirror assembly, wherein the light emitter, when electrically operated, emits near infrared light to illuminate at least a portion of the interior cabin that is viewed by the interior-viewing camera;
an electronic control unit (ECU) disposed at the vehicle, wherein the ECU comprises electronic circuitry and associated software, and wherein the electronic circuitry of the ECU comprises an image processor operable to process image data captured by the interior-viewing camera;
wherein image data captured by the interior-viewing camera is transferred to and is processed at the ECU;
wherein the vehicular cabin monitoring system, via processing at the ECU of image data captured by the interior-viewing camera, (i) determines attentiveness of a driver of the vehicle, (ii) detects presence of a passenger occupying a passenger seat within the interior cabin of the vehicle and (iii) determines posture of the passenger relative to the passenger seat that is occupied by the passenger; and
wherein, based at least in part on the determined posture of the passenger relative to the passenger seat that is occupied by the passenger, improper posture of the passenger relative to the passenger seat that is occupied by the passenger is determined.

21. The vehicular cabin monitoring system of claim 20, wherein image data captured by the interior-viewing camera is processed at the ECU to determine skeletal structure of the passenger mapped from a perceived body position of the passenger.

22. The vehicular cabin monitoring system of claim 20, wherein proper posture of a properly-postured passenger relative to the passenger seat that is occupied by the passenger is stored in memory, and wherein a threshold degree of improper posture of the passenger is determined by the vehicular cabin monitoring system by comparing the determined posture of the passenger relative to the passenger seat that is occupied by the passenger to the proper posture stored in memory.

23. The vehicular cabin monitoring system of claim 22, wherein an alert is generated responsive to the determined posture of the passenger relative to the passenger seat that is occupied by the passenger being different than the proper posture stored in memory by at least a threshold amount.

24. The vehicular cabin monitoring system of claim 20, wherein the vehicular cabin monitoring system, via processing at the ECU of image data captured by the interior-viewing camera, determines posture of the driver relative to a driver seat that is occupied by the driver.

25. The vehicular cabin monitoring system of claim 24, wherein posture of the driver is determined based at least in part on a determined head position of the driver relative to a steering wheel of the vehicle.

26. The vehicular cabin monitoring system of claim 20, wherein posture of the passenger is determined based at least in part on a determined spinal position of the passenger relative to the passenger seat that is occupied by the passenger.

27. The vehicular cabin monitoring system of claim 20, wherein an alert is generated responsive to determination of a threshold degree of improper posture.

28. The vehicular cabin monitoring system of claim 27, wherein the alert comprises actuation of a visible indicator that is viewable by the passenger of the vehicle.

29. The vehicular cabin monitoring system of claim 28, wherein the visible indicator is disposed at the interior rearview mirror assembly of the vehicle.

30. The vehicular cabin monitoring system of claim 28, wherein the visible indicator comprises a light emitting diode.

31. The vehicular cabin monitoring system of claim 28, wherein the alert comprises actuation of the visible indicator to emit red light.

32. The vehicular cabin monitoring system of claim 28, wherein the visible indicator emits green light when the vehicular cabin monitoring system is operating and the vehicular cabin monitoring system does not determine improper posture.

33. The vehicular cabin monitoring system of claim 28, wherein the visible indicator comprises an iconistic graphic overlay that is overlaid at video images displayed at a video display screen of the vehicle that is viewable by the passenger of the vehicle.

34. The vehicular cabin monitoring system of claim 33, wherein the video display screen is disposed at the interior rearview mirror assembly of the vehicle.

35. The vehicular cabin monitoring system of claim 27, wherein the alert comprises an audible alert.

36. The vehicular cabin monitoring system of claim 27, wherein the alert comprises a haptic alert.

37. A vehicular cabin monitoring system, the vehicular cabin monitoring system comprising:
an interior-viewing camera disposed at an interior rearview mirror assembly within an interior cabin of a vehicle equipped with the vehicular cabin monitoring system, wherein the interior-viewing camera views within the interior cabin of the vehicle;
wherein the interior-viewing camera is operable to capture image data;
a light emitter disposed at the interior rearview mirror assembly, wherein the light emitter, when electrically operated, emits near infrared light to illuminate at least a portion of the interior cabin that is viewed by the interior-viewing camera;
wherein the light emitter comprises at least one near infrared light emitting diode;
an electronic control unit (ECU) disposed at the vehicle, wherein the ECU comprises electronic circuitry and associated software, and wherein the electronic circuitry of the ECU comprises an image processor operable to process image data captured by the interior-viewing camera;
wherein image data captured by the interior-viewing camera is transferred to and is processed at the ECU;
wherein the vehicular cabin monitoring system, via processing at the ECU of image data captured by the interior-viewing camera, (i) determines posture of a driver relative to a driver seat that is occupied by the driver, (ii) detects presence of a passenger occupying a passenger seat within the interior cabin of the vehicle and (iii) determines posture of the passenger relative to the passenger seat that is occupied by the passenger;
wherein, based at least in part on the determined posture of the passenger relative to the passenger seat that is occupied by the passenger, improper posture of the passenger relative to the passenger seat that is occupied by the passenger is determined; and
wherein, based at least in part on the determined posture of the driver relative to the driver seat that is occupied by the driver, improper posture of the driver relative to the driver seat that is occupied by the driver is determined.

38. The vehicular cabin monitoring system of claim 37, wherein image data captured by the interior-viewing camera is processed at the ECU to determine skeletal structure of the passenger mapped from a perceived body position of the passenger.

39. The vehicular cabin monitoring system of claim 37, wherein proper posture of a properly-postured passenger relative to the passenger seat that is occupied by the passenger is stored in memory, and wherein a threshold degree of improper posture of the passenger is determined by the vehicular cabin monitoring system by comparing the determined posture of the passenger relative to the passenger seat that is occupied by the passenger to the proper posture stored in memory.

40. The vehicular cabin monitoring system of claim 39, wherein an alert is generated responsive to the determined posture of the passenger relative to the passenger seat that is occupied by the passenger being different than the proper posture stored in memory by at least a threshold amount.

41. The vehicular cabin monitoring system of claim 37, wherein posture of the driver is determined based at least in part on a determined head position of the driver relative to a steering wheel of the vehicle.

42. The vehicular cabin monitoring system of claim 37, wherein posture of the passenger is determined based at least in part on a determined spinal position of the passenger relative to the passenger seat that is occupied by the passenger.

43. The vehicular cabin monitoring system of claim 37, wherein an alert is generated responsive to determination of a threshold degree of improper posture.

44. The vehicular cabin monitoring system of claim 43, wherein the alert comprises actuation of a visible indicator that is viewable by the passenger of the vehicle.

45. The vehicular cabin monitoring system of claim 37, wherein the vehicular cabin monitoring system, via processing at the ECU of image data captured by the interior-viewing camera, determines attentiveness of the driver of the vehicle.
